(19) United States
(12) Patent Application Publication
(10) Pub. No.: US 2012/0042379 A1
(43) Pub. Date: Feb. 16, 2012

(54) SYSTEM AND METHOD FOR DETECTING GENUINE COPIES OF PRE-RECORDED DIGITAL MEDIA

(75) Inventors: Eric Diehl, Liffre (FR); Mohamed Karroumi, Rennes (FR); Michel Morvan, Bretagne (FR); Christophe Vincent, Chevaigne (FR); Ben Crosby, Murphy, TX (US)

(73) Assignee: THOMAS LICENSING

(21) Appl. No.: 13/138,904

(22) PCT Filed: Apr. 22, 2010
(86) PCT No.: PCT/EP2010/055331

§ 371 Date: Oct. 21, 2011

(30) Foreign Application Priority Data
Apr. 28, 2009 (EP) 09305365.0

(51) Int. Cl. G06F 21/00

(52) U.S. Cl. 726/19

(57) ABSTRACT

To authenticate a digital medium for a given title, an authentication server selects a number of challenges corresponding to the title from an authentication database, clears an error counter and sends the challenges sequentially to an authentication application in a media reader in which the digital medium is inserted. Upon reception of a response, it is verified if the answer is correct. If this is the case, then the next challenge is sent; otherwise, it is first verified if a correct answer was mandatory and if so, it is deduced that the digital medium is not genuine. If an incorrect may be accepted, then the error counter is incremented and the next challenge is sent. When there are no more challenges to send, it is verified if the error counter is above an acceptable limit. If so, the digital medium is deemed as not genuine. The invention may be used to allow an owner of a digital medium to access further information or content.

### TECHNICAL FIELD

The present invention relates generally to pre-recorded digital media, and more particularly to a system for offering services to users that possess a genuine pre-recorded medium.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Given the wide-spread copying of digital content—for example films, music and computer programs—there is an interest for the provider of the digital content to detect whether or not a user possesses a genuine copy of a digital medium storing such digital content. Such a digital medium may for instance be a DVD, a CD-ROM or a Blu-ray™ disc.

The content provider may then deliver further services and content than those originally provided with the digital medium. Examples of these comprise providing bonus tracks and providing enhanced versions that were not ready when the digital medium was manufactured. This may be done for free, but it may also be at a cost that is lower than it would be for customers who do not possess such a medium.

A typical test that is sometimes implemented verifies whether or not the digital medium is recordable or not. If it is recordable, then it cannot be a pre-recorded medium. Nevertheless, this is insufficient to prove the ownership of a given title.

The game industry uses systems, for instance SecuROM provided by Sony, that measure “physical” characteristics of a disc. Unfortunately, such systems are often defeated by emulation software such as Alcohool120% and Daemon Tools.

WO 01/90860 proposes another method for authenticating that a user possesses a specified pre-recorded digital medium. Such ownership allows the user to download further content or information. The user places the medium in a driver, downloads an application from the Internet, and executes that application. The application then accesses the medium via its driver and generates an identifier for the medium. The identifier is then sent to a script on the Internet that confirms or not that the medium is the selected medium. In this case, further download is allowed.

The application generates a unique identifier for the medium by combining at least two attributes in an algorithm. Such attributes may be “the number of tracks, the length of each track, and the total track length”. The unique identifier should provide a reasonable indication that the medium is the correct medium.

The unique identified is then passed over the Internet to a verification script that compares the unique identifier thus received with a stored identifier. In case of a match, the script instructs the application to start the download of the additional features.

This solution is unfortunately not very secure and it is believed that hackers may easily overcome any security provided by it.

It can therefore be appreciated that there is a need for a solution that overcomes these problems and increases the security. The present invention provides such a solution.

### SUMMARY OF INVENTION

In a first aspect, the invention is directed to a system for authentication of a pre-recorded digital medium. The system comprises an authentication server adapted to authenticate the pre-recorded digital medium, a media reader comprising a media driver adapted to interact with the pre-recorded digital medium, and an authentication application adapted to be executed on the media reader and to interact with the media driver to obtain information about the pre-recorded digital medium. The authentication server is adapted to store, for the pre-recorded digital medium, a set of challenges and corresponding expected responses; send a plurality of challenges, selected from the set of challenges, to the authentication application, each challenge requesting information about a characteristic of the pre-recorded digital medium, wherein correct responses to at least a subset of the plurality of challenges allow authentication of the pre-recorded digital medium; receive responses corresponding to the plurality of challenges from the authentication application; authenticate the pre-recorded digital medium if the responses to at least the subset of the plurality of challenges are correct; and update a set of challenges and corresponding responses for a pre-recorded digital medium.

In a first preferred embodiment, the authentication server is adapted to accept a number of false responses. It is advantageous that there are challenges to which a correct answer is mandatory.

In a second preferred embodiment, the authentication server is adapted to allow the media reader to download content upon successful authentication of the pre-recorded digital medium.

In a third preferred embodiment, the authentication server is further adapted to receive, from the authentication application, a request to authenticate the pre-recorded digital medium.

In a fourth preferred embodiment, the authentication server is further adapted to send the plurality of challenges in a determined order. It is advantageous that the determined order of the plurality of challenges is random.

In a fifth preferred embodiment, the plurality of challenges is a subset of the stored set of challenges.

In a second aspect, the invention is directed to a method of authenticating a pre-recorded digital medium in a media reader. An authentication server selects a plurality of challenges from a stored set of challenges, wherein the plurality of challenges is a subset of the stored set of challenges; sends the plurality of challenges to the authentication application, each challenge requesting information about a characteristic of the pre-recorded digital medium, wherein correct responses to at least a subset of the plurality of challenges allow authentication of the pre-recorded digital medium; receives responses corresponding to the plurality of challenges from the authentication application; and authenticates the pre-recorded digital medium if the responses to at least the subset of the plurality of challenges are correct.

In a first preferred embodiment, the answer to a first challenge is received before the next challenge is sent.

In a second preferred embodiment, each received answer is verified, and it is verified if an incorrect answer corresponded to a challenge to which a correct answer is mandatory and, if so, the pre-recorded digital medium is not authenticated. It is advantageous that an error counter is incremented for each incorrect answer and that the pre-recorded digital medium is authenticated if the error counter has not attained a threshold value.

In a third preferred embodiment, an authenticated pre-recorded digital medium is deemed to be a genuine pre-recorded digital medium.

In a third aspect, the invention is directed to a method of authenticating a pre-recorded digital medium in a media reader. An authentication application executed on the media reader obtains a plurality of challenges, each challenge requesting information about a characteristic of the pre-recorded digital medium, wherein correct responses to at least a subset of the plurality of challenges allow authentication of the pre-recorded digital medium; obtains an expected answer to each obtained challenge; requests information regarding the characteristic of the pre-recorded digital medium from a media driver of the media reader; receives an answer to each challenge from the media driver; and authenticates the pre-recorded digital medium if the responses to at least the subset of the plurality of challenges are correct.

### BRIEF DESCRIPTION OF DRAWINGS

Preferred features of the present invention will now be described, by way of non-limiting example, with reference to the accompanying drawings, in which

FIG. 1 illustrates schematically the system according to a preferred embodiment of the present invention;

FIG. 2 illustrates a flowchart for an authentication method according to a preferred embodiment of the present invention; and

FIG. 3 illustrates a title record according to a preferred embodiment of the present invention.

### DESCRIPTION OF EMBODIMENTS

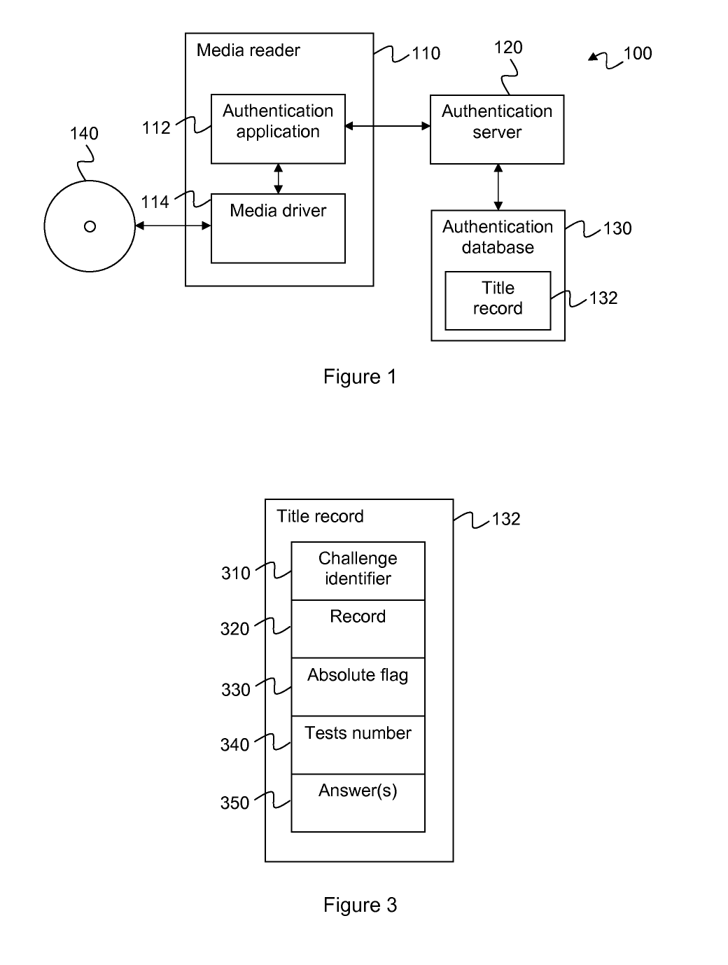

FIG. 1 illustrates schematically the system according to a preferred embodiment of the present invention.

The system 100 comprises a media reader 110 adapted to read a digital medium 140. The media reader 110 comprises a media driver 114 adapted to read the digital medium 140 and an authentication application 112 adapted to communicate, preferably over the Internet, with an authentication server 120 and to give instructions to the media driver 114. The system 100 also comprises the authentication server 120, which is adapted to interact with an authentication database 130, which advantageously is a SQL database such as mySQL.

When a user wants to have the medium 140 authenticated, it instructs the media reader 110 to initiate the authentication. The media reader 110 then uses the media driver 114 to read the title or other preferably unique identifier of the digital medium 140. It is advantageous that the media driver 114 also reads an identity of the authentication server 120 to use for authentication of the digital medium 140. The authentication application 112 then informs the authentication server 120 that it wants digital medium “Title” authenticated.

The skilled person will appreciate that other ways to initiate authentication are possible, such as having the user connect to a download site provided by the content provider and then having this site contact the authentication server 120 when the user desires to download specific content. In this case, the authentication server 120 may send instructions to the media reader 110 in order to ensure that the digital medium 140 is inserted therein. Such instructions may comprise a message to the user.

The authentication server 120 retrieves, preferably at random, from the authentication database 130 a number of challenges that it sends, either singly or grouped, to the authentication application 112, possibly encrypted. Using random challenges can overcome the use by hackers of response databases to find the correct response. The authentication database 130 stores, for each digital medium, a title record 132 comprising a plurality of challenges and the corresponding responses.

Each challenge preferably has two characteristics:
Whether the challenge is unique or multiple. A unique challenge has a unique value to be checked, whereas a multiple challenge can check multiple values and, possibly, return multiple values.
Whether or not the challenge is absolute. An absolute challenge requires an exact answer, while a non-absolute challenge may tolerate errors.

For each challenge, the title record 132 preferably comprises:
A challenge identifier that is unique for this type of challenge; the same type of challenge uses the same challenge identifier throughout the authentication database 130. It will however be appreciated that, the answers to the challenges may be different for different titles.
A challenge record that contains all possible responses. In the case of a unique challenge, there is only one value. In the case of a multiple challenge there are ordered values.

Upon reception of a challenge, the authentication application 112 sends a set of corresponding commands to the media driver 114. The set of commands is advantageously given by the challenge identifier. The authentication application 112 then receives the response (or responses) from the media driver 114 and sends this to the authentication application 120 that verifies whether or not the response matches the expected answer.

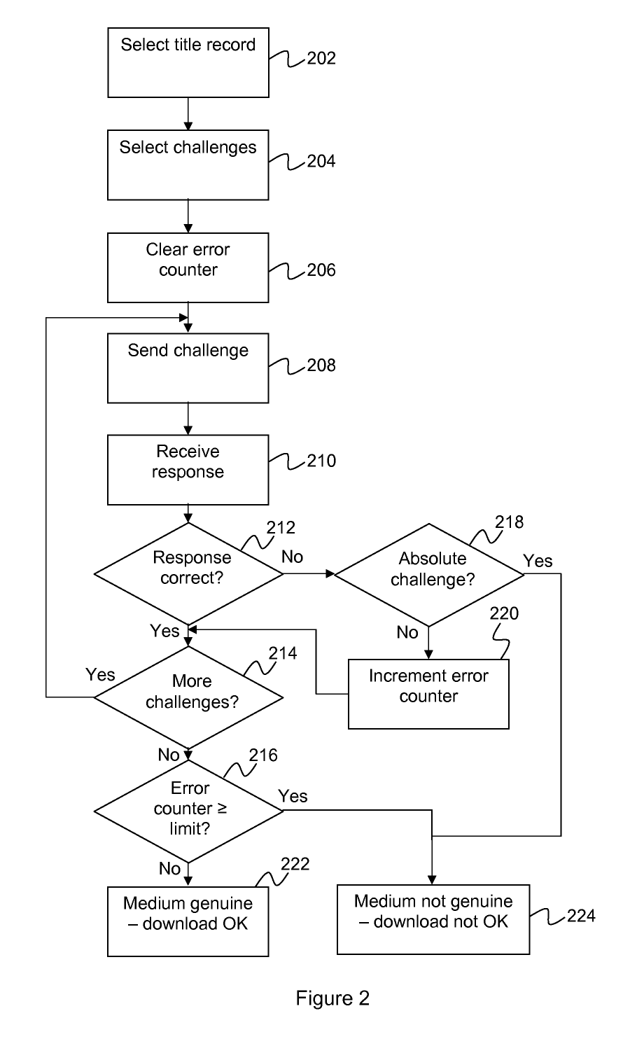

FIG. 2 illustrates a flowchart for an authentication method according to a preferred embodiment of the present invention.

The authentication server 120 selects 202 in the authentication database 130 the title record 132 corresponding to the title to verify. The authentication server 120 then selects 204 a set of challenges for the title and resets 206 an error counter. The first selected challenge is then sent 208 to the authentication application 112.

If the challenge is unique, then the authentication application 112 sends the corresponding commands to the media driver 114 and receives a unique response that it returns to the authentication server 120.

However, if the challenge is multiple, then the authentication server 120 selects randomly among the authentication values before sending 208 the challenge to the authentication application 112. The authentication application 112 sends the corresponding commands to the media driver 114 and receives a set of responses that it returns to the authentication server 120.

Upon reception 210 of the response, the authentication server 120 checks 212 if the response is correct. If this is the case, then it is checked 214 if there are more challenges to send; if so, a new challenge is sent 208 as described hereinbefore.

However, if the answer is not correct, then it is verified 218 if the challenge is absolute, i.e. if errors are tolerated or not. If the challenge is not absolute, then the error counter is incremented 220 and the method then continues with step 214, where it is checked if there are remaining challenges to be sent. On the other hand, if the challenge is absolute (and the answer was incorrect) then it is deduced 224 that the medium is not genuine, which means that any download or other services are not provided.

When it is determined in step 214 that there are no more challenges to be sent, then the error counter is compared 216 to a limit value. If the comparison shows that there are not too many errors, then it is deemed 222 that the medium is genuine and that the further content and/or services may be obtained. However, in the opposite case, the method goes to step 224 described hereinbefore.

In a variant embodiment, it is the authorisation application 112 that authenticates the digital medium 140. In this case, the challenges may be provided in the authorisation application 112 itself, but it is also possible for it to request challenges from the authentication server 120 and receive the necessary challenges and responses afterwards, not necessarily at the same time. When the authentication application 112 has authenticated the digital medium 140, it allows download of further content.

An advantage of the variant embodiment is that the load on the application server 120 can be lessened.

FIG. 3 illustrates a title record according to a preferred embodiment of the present invention. The title record 132 comprises:
A challenge identifier 310.
A challenge record 320 that depends on the challenge. It may contain information necessary to find the proper response, such as for example a physical address on the digital medium to read from.
An absolute challenge flag 330. This flag is ‘true’ if the challenge is absolute and ‘false’ otherwise.
A challenge tests number 340, whose value is the number of potential values that can be tested. For a unique challenge, the value is one; for a multiple challenge, it corresponds to the number of possible tests.
One or more expected answers 350.

A number of examples of challenges that will be further described hereinafter are:
Disc Type,
Disc recorded length, and
Track length.

The Disc Type challenge verifies information in the so-called lead-in area of a digital medium, such as a DVD that will be used hereinafter as a non-limitative example. The lead-in area comprises physical information, such as the disc type, the start and end positions of tracks, and so on.

A first challenge using this information is to check the disc type to see if the DVD is a recordable DVD or a DVD-ROM. Parameters are:
Challenge identifier 310=TEST_DISC_TYPE
Challenge record 320=void
Absolute challenge flag 330=TRUE
Challenge tests number 340=1
Answer 350=DVD_ROM

It will be appreciated that this challenge is absolute and that a single answer is expected: if the answer is ‘DVD_ROM’, then the medium passed this test, but the medium will be deemed not to be genuine in any other case.

A second challenge checks the DVD track length. Parameters are:
Challenge identifier 310=TEST_TOTAL_TRACK_LENGTH
Challenge record 320=void
Absolute challenge flag 330=FALSE
Challenge tests number 340=1
Answer 350=‘first possible length’, ‘second possible length’

As can be seen, this challenge is not absolute, which means that no immediate decision will be taken in case the answer is incorrect. Only one answer is expected, but it may take any one of two different values.

A third challenge checks the track length of a set of randomly chosen tracks of the disc. Parameters are:
Challenge identifier 310=TEST_TRACK_LENGTH
Challenge record 320=a set of ordered Boolean flags; each true represents a track to check.
Absolute challenge flag 330=FALSE
Challenge tests number 340=The maximum number of tracks.
Answer 350=the expected track lengths

The authentication server 120 advantageously selects a plurality of tracks to check. It sends a challenge with the list to the authentication application 112, which commands the media driver 114 (in this case a DVD driver) to return, for each indicated track, the length of the track. The authentication application 112 then returns these lengths (or a sum thereof).

The challenge may be considered successful if there is at most one wrong answer, but it is naturally also possible to require a different number of correct answers, in particular to require all of them to be correct.

An exemplary authentication process for a given digital medium 140—in this case a DVD—comprises the three challenges described hereinbefore, sent sequentially by the authentication server 120 to the authentication application 112. The limit for the error counter may be set to 2, i.e. if the error counter is greater than 1, then the DVD is considered as non-genuine. Examples of possible results of the authentication process include:
If the authentication server 120 receives correct responses for the ‘disc type’ challenge and the ‘total length’ challenge, and an incorrect response for the ‘track length’ challenge, then the DVD is considered genuine. There is only one error and that for a challenge that is not absolute.
If authentication server 120 receives good responses for the ‘total length’ challenge, the ‘track length’ challenge and an incorrect response for the ‘disc type’ challenge, then the DVD is considered not genuine. While there is a single error—i.e. the error limit is not attained—the error occurred for an absolute challenge.
If authentication server 120 receives a good response for the ‘disc type’ challenge, and incorrect responses for the ‘total length’ challenge and the ‘track length’ challenge, then the DVD is considered not genuine. While no absolute channel failed, the error counter attained the limit value.

It should be noted that it is possible for discs of the same title to have different instances, for instance if they are manufactured from different masters. In this case, the title may have a plurality of title records. The authentication server then preferably sequentially uses the title records until it receives a satisfactory answer or until there are no more title records.

It is preferred to protect the communication between the authentication server 120 and the authentication application 112. Examples of protections that may be applied comprise:
Mutual authentication between the authentication application 112 and the authentication server 120. Each of these advantageously has a certificate with a unique 1024-bit RSA key pair that may be used for prior art RSA authentication. The authentication server 120 checks that the certificate of the authentication application 112 is valid and that it is not entered in a revocation list.
Use of a common session key to protect the communication. For instance, AES with a 128-bit session key may be used.
The use of nonces to mask challenges and/or to ensure that an answer may not be reused. Nonces can be for example used by the authentication application 112 to send dummy commands to the media driver 114 or by the authentication server 120 to set the order of the different challenges.

The present authentication system can allow verification that a user possesses a legitimate instance of a given title. The use of a remote database of challenges and the fact that the verification occurs in the authentication server 120 and not on media reader can offer a greater resistance to attacks, as anti-copy solutions operating on the user's media reader are prone to reverse engineering attacks.

The storage of Challenge records 320 in an authentication database 130 allows updating of these challenges if they are defeated for one title. Existing challenges in the database may then be replaced or extended with new ones.

It will be appreciated that the present invention can allow a more flexible way of authenticating a digital support than the ones found in the prior art. In particular, as the challenges can be changed easily and their order modified, it can be possible to overcome replay attacks that some prior art methods may have been subject to.

Each feature disclosed in the description and (where appropriate) the claims and drawings may be provided independently or in any appropriate combination. Reference numerals appearing in the claims are by way of illustration only and shall have no limiting effect on the scope of the claims.

1. A system for authentication of a pre-recorded digital medium, the system comprising:
an authentication server adapted to authenticate the pre-recorded digital medium;
a media reader comprising a media driver adapted to interact with the pre-recorded digital medium;
an authentication application adapted to be executed on the media reader and to interact with the media driver to obtain information about the pre-recorded digital medium;
wherein the authentication server is adapted to:
store, for the pre-recorded digital medium, a set of challenges and corresponding expected responses;
send a plurality of challenges, selected from the set of challenges, to the authentication application, each challenge requesting information about a characteristic of the pre-recorded digital medium, wherein correct responses to at least a subset of the plurality of challenges allow authentication of the pre-recorded digital medium;
receive responses corresponding to the plurality of challenges from the authentication application;
authenticate the pre-recorded digital medium if the responses to at least the subset of the plurality of challenges are correct; and
update a set of challenges and corresponding responses for a pre-recorded digital medium.

2. The system of claim 1, wherein the authentication server is adapted to accept a number of false responses.

3. The system of claim 2, wherein there are challenges to which a correct answer is mandatory.

4. The system of claim 1, wherein the authentication server is adapted to allow the media reader to download content upon successful authentication of the pre-recorded digital medium.

5. The system of claim 1, wherein the authentication server is further adapted to receive, from the authentication application, a request to authenticate the pre-recorded digital medium.

6. The system of claim 1, wherein the authentication server is further adapted to send the plurality of challenges in a determined order.

7. The system of claim 6, wherein the determined order of the plurality of challenges is random.

8. The system of claim 1, wherein the plurality of challenges is a subset of the stored set of challenges.

9. A method of authenticating a pre-recorded digital medium in a media reader, the method comprising the steps, at an authentication server of:
selecting a plurality of challenges from a stored set of challenges, wherein the plurality of challenges is a subset of the stored set of challenges;
sending the plurality of challenges to the authentication application, each challenge requesting information about a characteristic of the pre-recorded digital medium, wherein correct responses to at least a subset of the plurality of challenges allow authentication of the pre-recorded digital medium;
receiving responses corresponding to the plurality of challenges from the authentication application; and
authenticating the pre-recorded digital medium if the responses to at least the subset of the plurality of challenges are correct.

10. The method of claim 9, wherein the answer to a first challenge is received before the next challenge is sent.

11. The method of claim 9, further comprising the steps of verifying each received answer, verifying if an incorrect answer corresponded to a challenge to which a correct answer is mandatory and, if so, not authenticating the pre-recorded digital medium.

12. The method of claim 11, further comprising the steps of incrementing an error counter for each incorrect answer and authenticating the pre-recorded digital medium if the error counter has not attained a threshold value.

13. The method of claim 9, wherein an authenticated pre-recorded digital medium is deemed to be a genuine pre-recorded digital medium.

14. A method of authenticating a pre-recorded digital medium in a media reader, the method comprising the steps, at an authentication application executed on the media reader, of:
obtaining a plurality of challenges, each challenge requesting information about a characteristic of the pre-recorded digital medium, wherein correct responses to at least a subset of the plurality of challenges allow authentication of the pre-recorded digital medium;
obtaining an expected answer to each obtained challenge;
requesting information regarding the characteristic of the pre-recorded digital medium from a media driver of the media reader;
receiving an answer to each challenge from the media driver; and
authenticating the pre-recorded digital medium if the responses to at least the subset of the plurality of challenges are correct.
